(19) United States
(12) Patent Application Publication
(10) Pub. No.: US 2003/0154255 A1
(43) Pub. Date: Aug. 14, 2003

(54) Method for reducing the spread of computer viruses in an electronic mail network

(76) Inventors: Hans-Joachim Platte, Hemmingen (DE); Wolfgang Fleischer, Hannover (DE)

Correspondence Address: Joseph S Tripoli, Patent Operations, Thomson Multimedia Licensing Inc, Cn 5312, Princeton, NJ, 08543-5312, US

(21) Appl. No.: 10/275,528

(22) PCT Filed: Apr. 27, 2001
(86) PCT No.: PCT/EP01/04747

(51) Int. Cl. G06F 15/16

(52) U.S. Cl. 709/206; 709/229

(57) ABSTRACT

The invention relates to a method for reducing the spread of computer viruses in an electronic mail network. In a mail server having a multiplicity of connected email subscriber computers, a method is installed which is used to test emails sent in succession to the subscribers or sent in succession by the subscribers for particular commonalities, and, depending on commonalities established, either to forward the emails automatically as intended or to retain them until another criterion arises.

The invention relates to a method for reducing the spread of computer viruses in an electronic mail network.

### PRIOR ART

In today's age of electronic mails and world-wide networking of computers, many forms of so-called computer viruses constitute great danger for companies operating their networked computers with connections to the electronic outside world as well. At the points of connection to the electronic outside world, such as the Internet, special computers are operated as so-called firewalls which, amongst other things, attempt to filter out emails containing electronic viruses externally before they can reach the companies' own computers. A virus is recognized by special software which, in each case, needs to be kept at the level of the latest virus patterns by the manufacturer.

However, between the appearance of a new virus and the creation and spread of a new virus pattern, a certain time elapses in which the virus can cause considerable damage. The method of virus recognition in the firewall computer is thus fundamentally susceptible. This is because, to produce a virus pattern, it is first necessary to recognize a virus, which is usually already connected to an instance of damage. If a virus is sent by the originator and is widely introduced into company networks at the same time, then damage limitation becomes a race against the time between the spread of the virus and the creation and installation of recognition programs. Particular structures mean that the virus can cause considerable damage within a few hours, which are required to create a recognition pattern, by causing the affected computers to send copies of itself to all the email addresses stored in this computer in snowball fashion, for example.

### INVENTION

The aim of this invention is to limit or interrupt the snowball-like forwarding chain of the virus.

The invention is achieved by means of the features specified in claim 1.

Advantageous developments can be found in the dependent claims.

According to the invention, in a mail server having a multiplicity of connected email subscriber computers, a method is installed which is used to test emails sent in succession to the subscribers or sent in succession by the subscribers for particular commonalities, and, depending on commonalities established, either to forward the emails automatically as intended or to retain them until another criterion arises.

The criterion which can be selected for the commonality established is the occurrence of the same subject line in a plurality of emails, the occurrence of the same text content, of an attachment which is the same, and/or the same or similarly timed sending or reception time.

If an electronic mail is automatically retained on account of one or more of these criteria, the mail server can forward an email query to the sending email subscriber to determine whether he actually wants to send all emails provided with substantial commonalities, and this sending email subscriber responds to this with an explicit acknowledgement.

What is claimed is:

1. (Amended) Method for reducing the spread of computer viruses in an electronic mail network, having a mail server and a multiplicity of email subscriber computers connected thereto, by emails sent in succession to the subscribers or sent in succession by the subscribers, [characterized in that] wherein the emails sent in succession to the subscribers or sent in succession by the subscribers are tested for particular commonalities and, depending on commonalities established, the electronic emails are either automatically forwarded as intended or are retained until another criterion arises.

2. (Amended) Method according to claim 1, [characterized in that] wherein the criterion used for the commonality established is the occurrence of the same subject line in a plurality of emails, the occurrence of the same text content, of an attachment which is the same, and/or the same or similarly timed sending or reception time.

3. (Amended) Method according to claim 1, [characterized in that] wherein, if an electronic mail is automatically retained on account of one or more of these criteria, the mail server forwards an email query to the sending email subscriber.

4. (Amended) Method according to claim 3, [characterized in that] wherein these emails provided with substantial commonalities are sent by the mail server if the sending email subscriber acknowledges the email query by the email server with an explicit acknowledgement.

5. (Amended) Method according to claim 4, [characterized in that] wherein the entry of an identifier or of a password is preferably used as an “explicit acknowledgement” from the sending email subscriber.

6. (Amended) Method according to claim 1, [characterized in that] wherein, as a further, different criterion, an email query is sent to the administrator of the network in question to determine whether he actually wants all emails provided with substantial commonalities to be sent, and this administrator responds to this with an explicit acknowledgement.

7. (Amended) Method according to claim 1, [characterized in that] wherein such characterized electronic mails are forwarded after a delay time has elapsed.

8. (Amended) Method according to claim 7, [characterized in that] wherein the time delay falls into a prescribed time frame, preferably into the normal working time of the administrator.
